(19) United States
(12) Patent Application Publication
(10) Pub. No.: US 2025/0138264 A1
(43) Pub. Date: May 1, 2025

(54) OPTICAL WAVEGUIDE DEVICE AND OPTICAL WAVEGUIDE-MOUNTED SUBSTRATE

(71) Applicant: SHINKO ELECTRIC INDUSTRIES CO., LTD., Nagano (JP)

(72) Inventors: Kazunao YAMAMOTO, Nagano (JP); Hisashi KANEDA, Nagano (JP)

(21) Appl. No.: 18/927,184

(22) Filed: Oct. 25, 2024

(30) Foreign Application Priority Data
Oct. 31, 2023 (JP) 2023-186365

(51) Int. Cl. G02B 6/42

(52) U.S. Cl. CPC G02B 6/4283; G02B 6/4267

(57) ABSTRACT

An optical waveguide device includes a silicon photonic chip having a main surface and including a silicon waveguide and an electrode, the silicon waveguide and the electrode being disposed on a same side of the silicon photonic chip as the main surface, and an optical waveguide laminated on the main surface of the silicon photonic chip, wherein the optical waveguide includes a core layer optically coupled to the silicon waveguide, a cladding layer having a first surface and a second surface opposite the first surface, the first surface being in contact with the main surface, the cladding layer covering at least a portion of the core layer, and a through interconnect penetrating the cladding layer and having one end surface connected to the electrode and another end surface exposed at the second surface.

### CROSS-REFERENCE TO RELATED APPLICATIONS

The present application is based on and claims priority to Japanese Patent Application No. 2023-186365 filed on Oct. 31, 2023, with the Japanese Patent Office, the entire contents of which are incorporated herein by reference.

### FIELD

The disclosures herein relate to optical waveguide devices and optical waveguide-mounted substrates.

### BACKGROUND

An optical waveguide device having silicon photonic chips and optical waveguides is used to transmit and receive signals in a data center or the like where various computers and data communication apparatuses are installed. In such an optical waveguide device, the core layer of an optical waveguide and the silicon waveguide of a silicon photonic chip are optically coupled to each other.

In the optical waveguide device described above, while the core layer of the optical waveguide needs to be covered with a cladding layer, the electrodes of the silicon photonic chip need to be exposed, so that a layer that would cover the electrodes is not provided at the position of the electrodes. With such an arrangement, there is a physical step between the lower surface of the optical waveguide and the surface of the silicon photonic chip where the electrodes are disposed. The optical waveguide device thus cannot be readily mounted on an interconnect substrate.

Accordingly, there may be a need to provide an optical waveguide device which can be readily mounted on an interconnect substrate.

### RELATED-ART DOCUMENT

### Patent Document

[Patent Document 1] International Publication Pamphlet No. WO2021/014720

### SUMMARY

According to an aspect of the embodiment, an optical waveguide device includes a silicon photonic chip having a main surface and including a silicon waveguide and an electrode, the silicon waveguide and the electrode being disposed on a same side of the silicon photonic chip as the main surface, and an optical waveguide laminated on the main surface of the silicon photonic chip, wherein the optical waveguide includes a core layer optically coupled to the silicon waveguide, a cladding layer having a first surface and a second surface opposite the first surface, the first surface being in contact with the main surface, the cladding layer covering at least a portion of the core layer, and a through interconnect penetrating the cladding layer and having one end surface connected to the electrode and another end surface exposed at the second surface.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a cross-sectional view illustrating an example of an optical waveguide device according to at first embodiment;

FIG. 2 is a cross-sectional view illustrating an example of an optical waveguide device according to a variation of the first embodiment;

FIG. 3 is a cross-sectional view illustrating an example of an optical waveguide-mounted substrate according to a second embodiment;

FIG. 4 is a cross-sectional view example of an optical waveguide-illustrating an mounted substrate according to a variation of the second embodiment;

FIG. 5 is cross-sectional view a illustrating an example of an optical waveguide-mounted substrate according to a third embodiment; and

FIG. 6 is a cross-sectional view illustrating an example of an optical waveguide-mounted substrate according to a variation of the third embodiment.

### DESCRIPTION OF EMBODIMENTS

In the following, embodiments of the present invention will be described with reference to the accompanying drawings.

In the following, embodiments of the invention will be described with reference to the accompanying drawings. In these drawings, the same components are referred to by the same reference numerals, and duplicate descriptions thereof may be omitted.

### First Embodiment

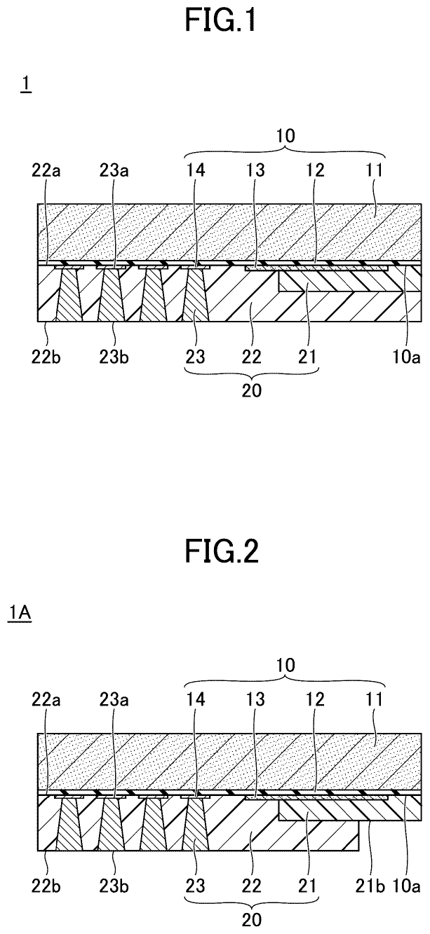

FIG. 1 is a cross-sectional view illustrating an example of an optical waveguide device according to the first embodiment. Referring to FIG. 1, the optical waveguide device 1 includes a silicon photonic chip 10 and an optical waveguide 20 laminated on a main surface 10a of the silicon photonic chip 10.

The silicon photonic chip 10 includes a silicon substrate 11, an insulating layer 12, a silicon waveguide 13, and electrodes 14. One surface of the silicon substrate 11 is covered with the insulating layer 12. The silicon waveguide 13 and the electrodes 14 are provided on the main surface 10a side of the silicon photonic chip 10.

The thickness of the silicon substrate 11 is, for example, about 100 μm to 800 μm. The silicon waveguide 13 is a fine optical waveguide, and is provided on the insulating layer 12 in the example of FIG. 1. The insulating layer 12 may be formed of, for example, SiO₂, SiOₓ, or the like. The thickness of the insulating layer 12 may be, for example, about 2 μm to 6 μm.

FIG. 1 shows only a non-limiting example, and the silicon waveguide 13 may be embedded in the silicon substrate 11. In this case, the surface of the silicon waveguide 13 facing toward the core layer 21 may or may not be exposed from the silicon substrate 11.

The electrodes 14 are electrically connected to an integrated circuit provided in the silicon photonic chip 10. The electrodes 14 may be formed of, for example, a metal such as copper or aluminum. Although provided on the insulating layer 12 in the example illustrated in FIG. 1, the electrodes 14 may be embedded in the silicon substrate 11. In this case, a portion of each of the electrodes 14 is exposed from the silicon substrate 11.

The optical waveguide 20 is laminated on the main surface 10a of the silicon photonic chip 10. The optical waveguide 20 includes a core layer 21, a cladding layer 22, and through interconnects 23.

The core layer 21 is in contact with the main surface 10a of the silicon photonic chip 10 and is optically coupled to the silicon waveguide 13. The mode of optical coupling between the core layer 21 and the silicon waveguide 13 does not matter. For example, the core layer 21 may be adiabatically coupled to the silicon waveguide 13, or may be directly coupled.

The width of the core layer 21 may be, for example, about 6 μm to 10 μm. The thickness of the core layer 21 may be, for example, about 6 μm to 10 μm. The refractive index of the core layer 21 is higher than that of the cladding layer 22 and may be, for example, about 1.6. The core layer 21 may be formed of, for example, a photosensitive resin such as a polyimide resin, an acrylic resin, an epoxy resin, a polyolefin resin, or a polynorbornene resin. A plurality of core layers 21 may be arranged side by side on the main surface 10a of the silicon photonic chip 10.

The cladding layer 22 has a first surface 22a and a second surface 22b opposite the first surface 22a. The first surface 22a of the cladding layer 22 is in contact with the main surface 10a of the silicon photonic chip 10. The cladding layer 22 covers at least a portion of the core layer 21. In the example illustrated in FIG. 1, the cladding layer 22 covers all of the surface of the core layer 21 situated on the opposite side from the main surface 10a and one longitudinal end of the core layer 21, with the other longitudinal end of the core layer 21 being exposed outside the cladding layer 22.

Preferably, the first surface 22a of the cladding layer 22 is in contact with the entire main surface 10a of the silicon photonic chip 10 except for a portion where the core layer 21 is provided. This arrangement reduces the likelihood of thermal stress occurring in the cladding layer 22, thereby reducing the risk of cracks occurring in the cladding layer detachment occurring between the cladding layer 22 and the silicon photonic chip 10.

The thickness of the cladding layer 22 may be, for example, about 10 μm to 30 μm. The refractive index of the cladding layer 22 may be, for example, about 1.5. The cladding layer 22 may be formed of, for example, a material selected as appropriate from those listed as examples of the material of the core layer 21.

Each of the through interconnects 23 penetrates the cladding layer 22 and has one end surface 23a thereof connected to a corresponding one of the electrodes 14 of the silicon photonic chip 10, and the other end surface 23b is exposed at the second surface 22b of the cladding layer 22. The area of the one end surface 23a of each through interconnect 23 is, for example, smaller than the area of the other end surface 23b. The through interconnects 23 may each have a truncated cone shape whose diameter gradually decreases from the other end surface 23b toward the one end surface 23a. The other end surfaces 23b of the through interconnects 23 may be flush with the second surface 22b, for example.

In order to form the through interconnects 23, for example, laser light is irradiated from the direction of the second surface 22b of the cladding layer 22 to form through holes penetrating the cladding layer 22. The through holes are then filled with copper or the like to form the through interconnects 23. In order to fill the through holes with copper or the like, for example, a semi-additive method may be used. According to need, the second surface 22b and the other end surfaces 23b may be polished for planarization.

In the optical waveguide device 1, the second surface 22b of the cladding layer 22 serves as a surface for mounting on an interconnect substrate, and the second surface 22b does not have a physical step like the one that is present in Patent Document 1 between the lower surface of the optical waveguide and the electrode bearing surface of the silicon photonic chip. This arrangement thus allows for the same handling as in the case of mounting a normal semiconductor chip on an interconnect substrate, thereby making it easy to mount the device on an interconnect substrate.

In Patent Document 1, solder is used to connect the semiconductor chip to the interconnect substrate, which requires the height of the solder to correspond to the step. Such a requirement inevitably leads to widening of the width of the solder, and, thus, it becomes difficult to arrange electrodes at a narrow pitch in the silicon photonic chip. In contrast, the optical waveguide device 1 does not have a structural step on the side of the cladding layer 22 where the second surface 22b serving as a mounting surface is situated. There is thus no need to use solder having a high height and a wide width for connection with an interconnect substrate, so that the electrodes 14 are allowed to be arranged at a narrow pitch.

### <Variation of First Embodiment>

A first variation of the first embodiment is directed to an example of an optical waveguide device in which the structure of an optical waveguide is different from that of the first embodiment. In connection with the first variation of the first embodiment, a description of the same components as those of the previously described embodiment may be omitted.

FIG. 2 is a cross-sectional view illustrating an example of an optical waveguide device according to the variation of the first embodiment. Referring to FIG. 2, an optical waveguide device 1A differs from the optical waveguide device 1 in that part of the lower surface 21b of the core layer 21 situated on the opposite side from the main surface 10a of the silicon photonic chip 10 is exposed outside the cladding layer 22.

As described above, part of the lower surface 21b of the core layer 21 may be exposed outside the cladding layer 22. This part of the lower surface 21b of the core layer 21 may be used for optical coupling with another waveguide or the like.

In the optical waveguide device 1A, there is a physical step at the boundary between the second surface 22b of the cladding layer 22 and the lower surface 21b of the core layer 21. However, the end surfaces 23b of the through interconnects 23 are located below the lower surface 21b, which is different from the configuration of Patent Document 1 in which the step is structured such that the electrodes are located at the higher level. There is thus little adverse effect during the process of mounting on an interconnect substrate.

### Second Embodiment

A second embodiment is directed to an example of an optical waveguide-mounted substrate in which the optical waveguide device according to the first embodiment is mounted on a substrate. In connection with the second embodiment, descriptions of the same components as those of the previously described embodiments may be omitted.

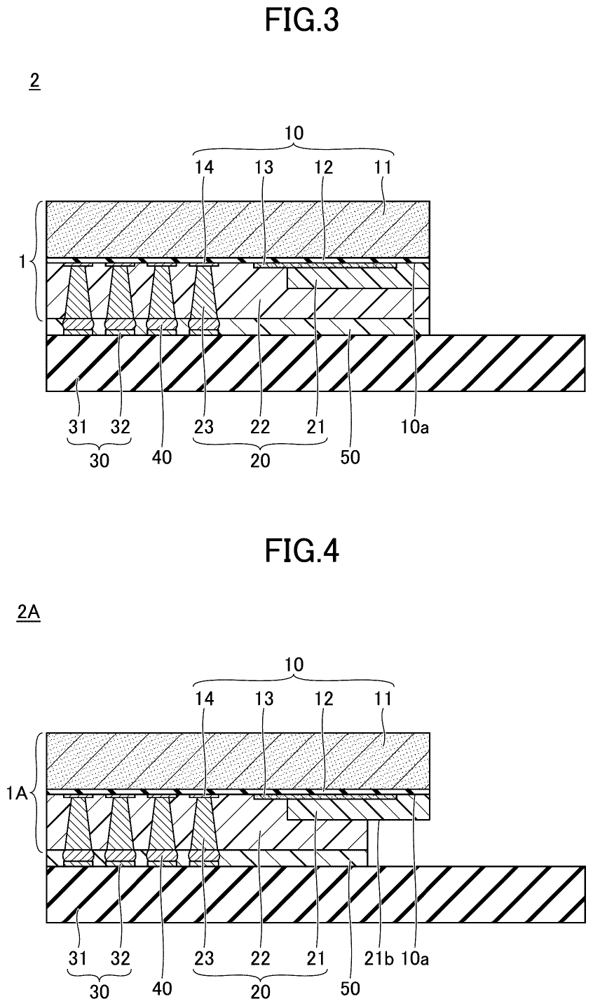

FIG. 3 is a cross-sectional view illustrating an example of an optical waveguide-mounted substrate according to the second embodiment. Referring to FIG. 3, an optical waveguide-mounted substrate 2 includes the optical waveguide device 1 and an interconnect substrate 30 having connection terminals 32 on one side thereof.

The interconnect substrate 30 includes an insulating layer 31, and the connection terminals 32 are arranged on the insulating layer 31. The interconnect substrate 30 may be a rigid substrate having high rigidity or a flexible substrate having low rigidity. The interconnect substrate 30 is, for example, a build-up substrate. The interconnect substrate 30 may be a silicon substrate or a ceramic substrate.

The optical waveguide device 1 is mounted on one side of the interconnect substrate 30 with the optical waveguide 20 facing toward the connection terminals 32. The through interconnects 23 of the optical waveguide device are 1 joined to the connection terminals 32 of the interconnect substrate 30 via joining members 40. The joining members 40 are, for example, solder.

It is preferable from the viewpoint of reliability to arrange an underfill resin 50 covering the joining members 40 between the opposing surfaces of the interconnect substrate 30 and the optical waveguide 20.

The optical waveguide device 1 has no structural step on the second surface 22b of the cladding layer 22, which serves as a surface for mounting on the interconnect substrate 30, and can thus be easily mounted on one side of the interconnect substrate 30, allowing the creation of the optical waveguide-mounted substrate 2.

### <Variation of Second Embodiment>

A variation of the second embodiment is directed to an example of an optical waveguide-mounted substrate in which the optical waveguide device according to the variation of the first embodiment is mounted on a substrate. In connection with the variation of the second embodiment, a description of the same components as those of the previously described embodiments may be omitted.

FIG. 4 is a cross-sectional view illustrating an example of an optical waveguide-mounted substrate according to the variation of the second embodiment. Referring to FIG. 4, an optical waveguide-mounted substrate 2A includes the optical waveguide device 1A and the interconnect substrate 30 having the connection terminals 32 on one side thereof. That is, the configuration of this variation is the same as the optical waveguide-mounted substrate 2 except that the optical waveguide device 1 is replaced with the optical waveguide device 1A.

The optical waveguide device 1A has a physical step at the boundary between the lower surface 21b of the core layer 21 and the second surface 22b of the cladding layer 22 serving as a surface for mounting on the interconnect substrate 30, but as previously described, there is little adverse effect during the process of mounting the optical waveguide device 1A on the interconnect substrate 30. The optical waveguide device 1A can thus be easily mounted on one side of the interconnect substrate 30, allowing the creation of the optical waveguide-mounted substrate 2A.

### Third Embodiment

A third embodiment is directed to an example in which a second optical waveguide device is further mounted on the optical waveguide-mounted substrate according to the second embodiment. In connection with the third embodiment, a description of the same components as those of the previously described embodiments may be omitted.

FIG. 5 is a cross-sectional view illustrating an example of an optical waveguide-mounted substrate according to the third embodiment. Referring to FIG. 5, an optical waveguide-mounted substrate 2B differs from the optical waveguide-mounted substrate 2 in that a second optical waveguide device 60 is mounted alongside the optical waveguide device 1 on one side of the interconnect substrate 30.

The second optical waveguide device 60 includes a support 61 and an optical fiber 62 provided in the support 61. The support 61 may be formed of, for example, resin. One end of the optical fiber 62 faces one longitudinal end of the core layer 21 of the optical waveguide device 1. The core layer 21 of the optical waveguide device 1 is optically coupled to the optical fiber 62.

There is a gap of about several tens of micrometers between the longitudinal end of the core layer 21 and the end of the optical fiber 62. An optical adhesive 70 is preferably disposed in the gap from the viewpoint of reliability.

In the optical waveguide-mounted substrate 2B, the optical waveguide device 1 and the second optical waveguide device 60 are mounted next to each other on the same side of the interconnect substrate 30, which allows the optical waveguide device 1 and the second optical waveguide device 60 to be easily optically coupled.

### <Variation of Third Embodiment>

A variation of the third embodiment is directed to an example in which a second optical waveguide device is further mounted on the optical waveguide-mounted substrate according to the variation of the second embodiment. In connection with the variation of the third embodiment, a description of the same components as those of the previously described embodiments may be omitted.

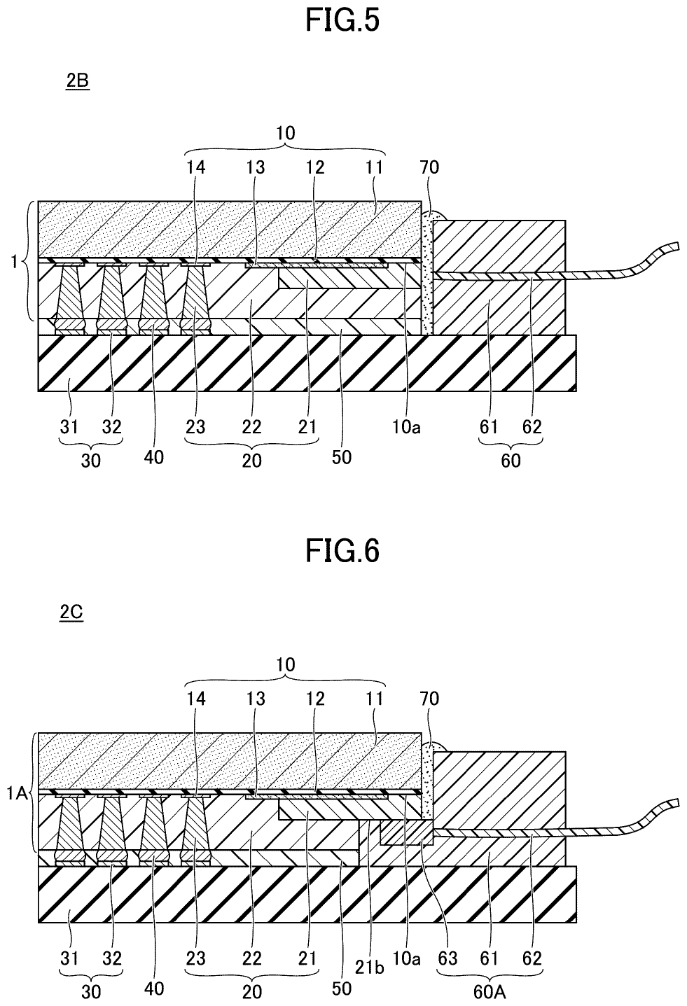

FIG. 6 is a cross-sectional view illustrating an example of an optical waveguide-mounted substrate according to the variation of the third embodiment. Referring to FIG. 6, an optical waveguide-mounted substrate 2C differs from the optical waveguide-mounted substrate 2A in that a second optical 60A is mounted alongside the optical waveguide device 1A on one side of the interconnect substrate 30.

The second optical waveguide device 60A includes a support 61, an optical fiber 62 provided in the support 61, and a second core layer 63 provided in the support 61. The second core layer 63 may be formed of, for example, substantially the same material as the core layer 21. The support 61 may be formed of, for example, substantially the same material as the cladding layer 22.

The second core layer 63 has a region overlapping in plan view with a surface of the core layer 21 exposed outside the cladding layer 22. The core layer 21 is adiabatically coupled to the second core layer 63, and the second core layer 63 is directly coupled to the optical fiber 62.

In the optical waveguide-mounted substrate 2C, the optical waveguide device 1A and the second optical waveguide device 60A can be easily optically coupled by mounting the optical waveguide device 1A and the second optical waveguide device 60A alongside each other on the same side of the interconnect substrate 30.

According to at least one embodiment of the disclosed technology, it is possible to provide an optical waveguide device that can be readily mounted on an interconnect substrate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An optical waveguide device comprising:
a silicon photonic chip having a main surface and including a silicon waveguide and an electrode, the silicon waveguide and the electrode being disposed on a same side of the silicon photonic chip as the main surface, and
an optical waveguide laminated on the main surface of the silicon photonic chip,
wherein the optical waveguide includes:
a core layer optically coupled to the silicon waveguide;
a cladding layer having a first surface and a second surface opposite the first surface, the first surface being in contact with the main surface, the cladding layer covering at least a portion of the core layer; and
a through interconnect penetrating the cladding layer and having one end surface connected to the electrode and another end surface exposed at the second surface.

2. The optical waveguide device according to claim 1, wherein the first surface is in contact with an entirety of the main surface except for a portion where the core layer is disposed.

3. The optical waveguide device according to claim 1, wherein the another end surface is flush with the second surface.

4. The optical waveguide device according to claim 1, wherein one longitudinal end of the core layer is covered with the cladding layer, and another longitudinal end of the core layer is exposed outside the cladding layer.

5. The optical waveguide device according to claim 4, wherein a surface of the core layer situated on an opposite side from the main surface has a portion thereof exposed outside the cladding layer.

6. An optical waveguide-mounted substrate comprising:
the optical waveguide device of claim 4; and
an interconnect substrate having a connection terminal on one side thereof;
wherein the optical waveguide device is mounted on the one side of the interconnect substrate with the optical waveguide facing toward the connection terminal, and
the through interconnect is joined to the connection terminal via a joining member.

7. The optical waveguide-mounted substrate according to claim 6, further comprising a second optical waveguide device mounted alongside the optical waveguide device on the one side of the interconnect substrate,
wherein the second optical waveguide device includes a support and an optical fiber provided in the support, and
the core layer is optically coupled to the optical fiber.

8. An optical waveguide-mounted substrate comprising:
the optical waveguide device of claim 5; and
an interconnect substrate having a connection terminal on one side thereof,
wherein the optical waveguide device is mounted on the one side of the interconnect substrate with the optical waveguide facing toward the connection terminal, and
the through interconnect is joined to the connection terminal through a joining member.

9. The optical waveguide-mounted substrate according to claim 8, further comprising a second optical waveguide device mounted alongside the optical waveguide device on the one side of the interconnect substrate;
wherein the second optical waveguide device includes a support, an optical fiber provided in the support, and a second core layer provided in the support, and
the core layer is adiabatically coupled to the second core layer, and the second core layer is directly coupled to the optical fiber.
